(19) United States
(12) Patent Application Publication
(10) Pub. No.: US 2017/0168522 A1
(43) Pub. Date: Jun. 15, 2017

(54) Flip Down Double Sided Touch Screen

(71) Applicant: Lenovo (Singapore) Pte. Ltd., Singapore (SG)

(72) Inventors: Robert J. Kapinos, Durham, NC (US); Joseph B. Morris, Cary, NC (US); Joaquin F. Luna, Durham, NC (US); Scott W. Li, Cary, NC (US)

(21) Appl. No.: 14/969,854

(22) Filed: Dec. 15, 2015

(51) Int. Cl. G06F 1/16; G06F 3/041; G06F 3/044; G06F 3/02

(52) U.S. Cl. CPC G06F 1/162; G06F 3/0221; G06F 3/0227; G06F 3/0412; G06F 3/044; G06F 1/1692; G06F 3/0416; G06F 2203/04101; G06F 2200/1614

(57) ABSTRACT

An approach is disclosed that provides a attached touch layer that can be rotated respective to, and independently of, a display component and a keyboard component. The display component is attached to the keyboard component. The touch layer can overlay the display screen component or the keyboard component. In addition, the touch layer can be at an intermediate position in between the display component and the keyboard component. Touch input can be received at both sides of the touch layer.

### BACKGROUND

Traditional touch screens are affixed to a component of an information handling system, such as a laptop, that provides touch-screen capabilities. These touch screens are usually affixed to the display screen surface. However, users that wish to draw using such affixed touch screen surfaces may find it difficult due to the vertical angle of the display. A touch screen can be integrated on a keyboard surface in lieu of, or in addition to, the display affixed touch screen. However, such keyboard affixed touch screen take up valuable space that could otherwise be used for keyboard keys and functions. Finally, a system could utilize two touch screens—one affixed to the display screen and one affixed to the keyboard—but this approach is not attractive due to the higher cost of manufacturing systems that include two touch screen surfaces.

### SUMMARY

An approach is disclosed that provides a hingeably attached touch layer that can be rotated respective to, and independently of, a display component and a keyboard component. The display component is hingeably attached to the keyboard component. The touch layer can overlay the display screen component or the keyboard component. In addition, the touch layer can be at an intermediate position in between the display component and the keyboard component. Touch input can be received at both sides of the touch layer.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages will become apparent in the non-limiting detailed description set forth below.

### BRIEF DESCRIPTION OF THE DRAWINGS

This disclosure may be better understood by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a diagram depicting different physical laptop orientations of the information handling system with a touch layer being moved between a display screen layer and a keyboard layer;

FIG. 4 is a diagram depicting different physical laptop orientations of the information handling system shown in a closed orientation, a standing orientation, and a tablet orientation; and

FIG. 5 is a flowchart showing steps performed to manage input from the touch layer based on the orientation of touch layer respective to other components of the information handling system.

### DETAILED DESCRIPTION

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The detailed description has been presented for purposes of illustration, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, aspects may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. As used herein, a computer readable storage medium does not include a computer readable signal medium.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclsoure are described below with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

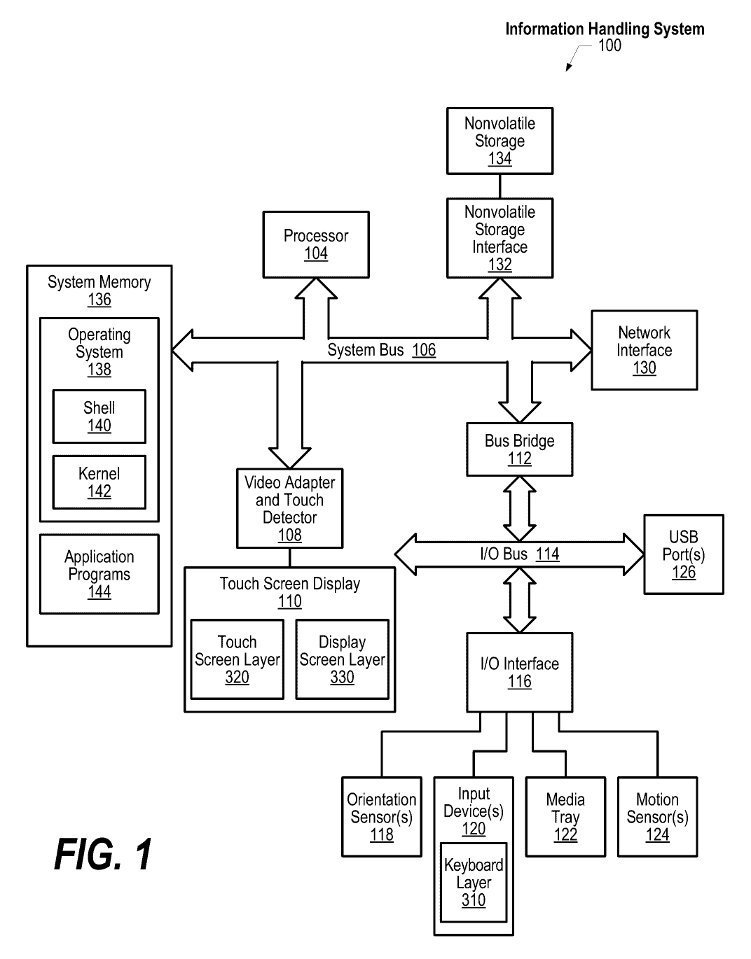

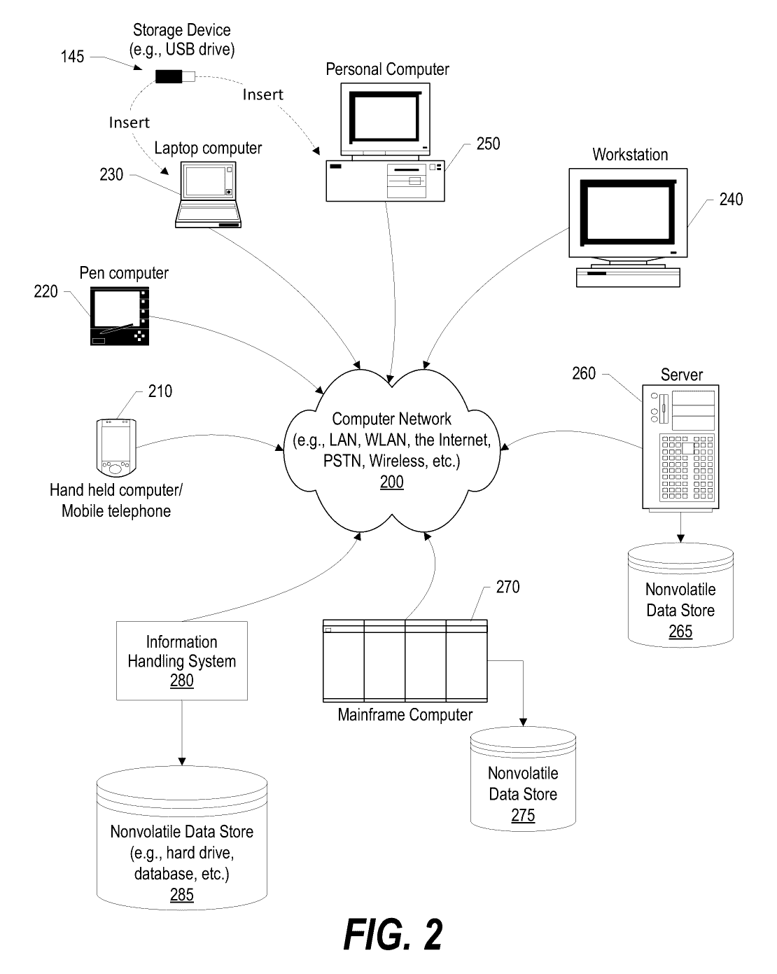

The following detailed description will generally follow the summary, as set forth above, further explaining and expanding the definitions of the various aspects and embodiments as necessary. To this end, this detailed description first sets forth a computing environment in FIG. 1 that is suitable to implement the software and/or hardware techniques associated with the disclosure. A networked environment is illustrated in FIG. 2 as an extension of the basic computing environment, to emphasize that modern computing techniques can be performed across multiple discrete devices.

FIG. 1 illustrates information handling system 100, which is a simplified example of a computer system capable of performing the computing operations described herein. Note that some or all of the exemplary architecture, including both depicted hardware and software, shown for and within information handling system 100 may be utilized by a software deploying server, such as one of the servers shown in FIG. 2.

Information handling system 100 includes processor 104 that is coupled to system bus 106. Processor 104 may utilize one or more processors, each of which has one or more processor cores. Video adapter 108, which drives/supports touch screen display 110, is also coupled to system bus 106. System bus 106 is coupled via bus bridge 112 to input/output (I/O) bus 114. I/O interface 116 is coupled to I/O bus 114. I/O interface 116 affords communication with various I/O devices, including orientation sensor 118, input device(s) 120, media tray 122 (which may include additional storage devices such as CD-ROM drives, multi-media interfaces, etc.), motion sensor 124, and external USB port(s) 126. Input devices 120 include keyboard layer 310 that, in one embodiment, provides a platform for the information handling system when the information handling system is configured in a laptop configuration. Also, in one embodiment, keyboard layer 310 is a hinged component that can be rotated, or moved, respective to touch layer 320 and display screen layer 330. In one embodiment, touch layer 320 is a rigid layer, while in an alternate embodiment, touch layer 320 is flexible. In one embodiment, touch layer 320 is coupled to at least one of the other components (touch screen display 110 or keyboard component 310) with a hinge, while in another embodiment the touch layer is coupled to at least one of the other components with another type of attachment mechanism.

Touch screen display 110 includes touch layer 320 which is a touch-sensitive grid that can be rotated by a hinge to overlay either keyboard layer 310 or display screen layer 330. Touch screen display 110 allows a user to enter inputs by directly touching touch screen display 110. In one embodiment, keyboard layer 310, touch layer 320, and display screen layer 330 are each attached via sets of hinges that allows each of these layers to be rotated, or moved, respective to the other layers.

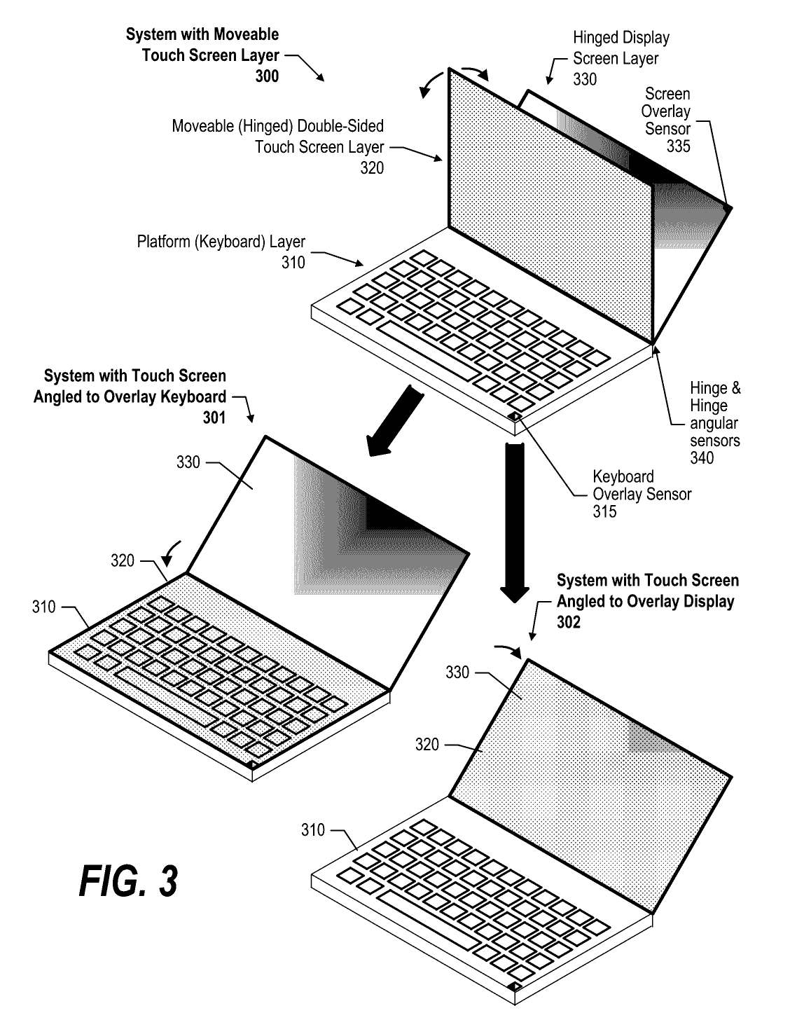

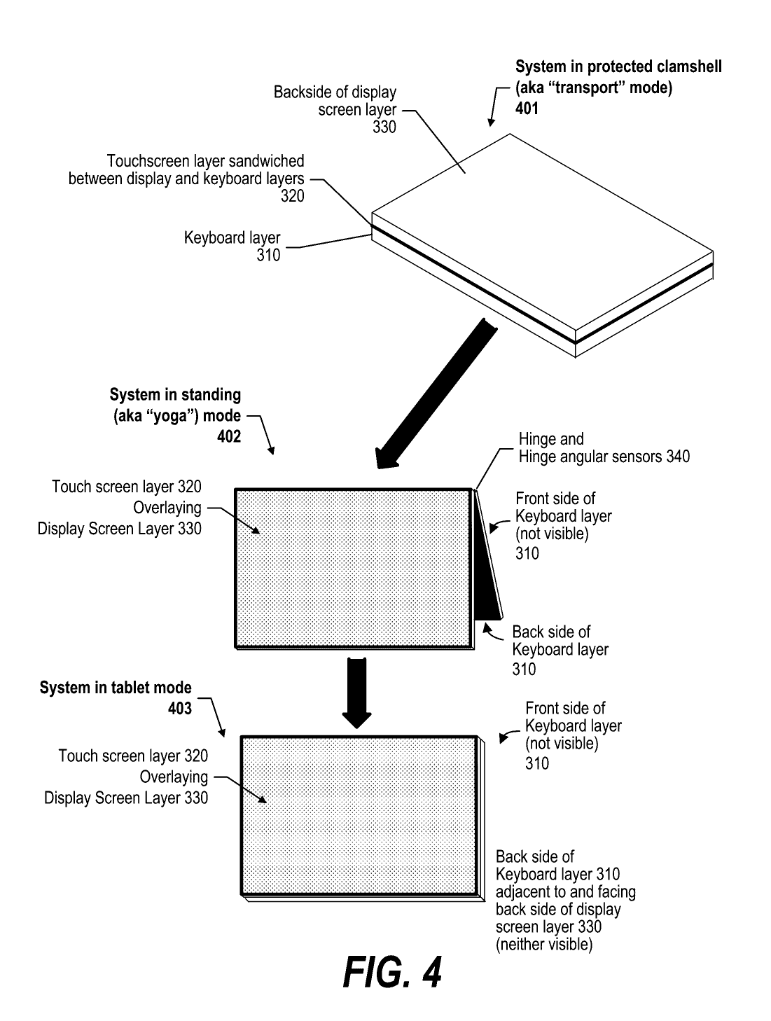

Orientation sensor(s) 118 are one or more sensors and/or associated logic that senses the physical/spatial orientation of information handling system 100. For example, a simple gravity detector can tell if the information handling system is being held right-side-up, upside down, parallel to or perpendicular to the ground (e.g., a walking surface), at some other angle relative to the ground, etc. In another example, orientation sensor 118 is a set of accelerometers, strain gauges, etc. that provide real-time information describing the physical orientation of information handling system 100 in three-dimensional space, including such orientation with respect to the earth/ground/floor. In addition, one or more orientation sensors 118 are used to depict the current configuration of the information handling system with a hinge connecting keyboard layer 310, touch layer 320, and display screen layer 330. These orientations provide orientation data pertaining to the various layers to ascertain, for example, if touch layer 320 is overlaying keyboard layer 310 or display screen layer 330. One or more of these orientation sensors determine if the display screen layer is positioned in a “portrait” mode or a “landscape” mode. Furthermore, data from orientation sensors 118 is used to determine if the information handling system is positioned in a traditional laptop mode (see examples, FIG. 3), a closed or “transport” mode (see example, FIG. 4), a standing or “yoga” mode (see example, FIG. 4), or some other physical configuration.

Motion sensor(s) 124 include one or more sensors and/or associated logic that senses the direction, speed, and/or acceleration of movement of information handling system 100 and components such as the keyboard layer, touch layer, and display screen layer. For example, a combination of accelerometers, strain gauges, etc. (described above with respect to orientation sensor 118) can also be used to detect how fast and in what direction information handling system 100 or the individual components is moving, as well as the acceleration of movement of information handling system 100 or the individual components. For example, motion sensor 124, either alone or in combination with the orientation sensor 118 described above, is able to detect if information handling system 100 is being handed from one person to another based on the rate of acceleration during the hand-off (e.g., faster than normal walking acceleration), the yaw orientation of information handling system 100 during the hand-off (e.g., a rotating movement indicating that the computer is being turned around for another person to see during a hand-off of the computer from one person to another), the pitch orientation of information handling system 100 during the hand-off (e.g., the front of information handling system 100 being tilted upwards during the hand-off of the computer from one person to another), and/or the roll orientation of information handling system 100 during the hand-off (e.g., a side of the computer rolling upwards during the hand-off of the computer of the computer from one person to another). In one embodiment, motion sensor 124 (alone or in combination with orientation sensor 118) is able to detect an oscillating motion of information handling system 100, such as that motion created with a user is walking and holding a tablet computer in her hand (and at her side) while swinging her arms forward and backward. In addition, motion sensors 124 is able to detect the movement of one or more of the layers included in the information handling system (keyboard layer 310, touch layer 320, and display screen layer 330). For example, motion sensors 124 can detect if the user is moving the touch layer in a direction to overlay the keyboard layer or the display screen layer. Likewise, motion sensors can detect that the user is moving the layers to position the information handling system in a traditional laptop orientation, a tablet orientation, a clamshell or “transport” orientation, or any other orientation possible with the information handling system. Information handling system 100 may be a tablet computer, a laptop computer, a smart phone, or any other computing device that has a keyboard layer, a touch layer, and a display screen layer.

Nonvolatile storage interface 132 is also coupled to system bus 106. Nonvolatile storage interface 132 interfaces with one or more nonvolatile storage devices 134. In one embodiment, nonvolatile storage device 134 populates system memory 136, which is also coupled to system bus 106. System memory includes a low level of volatile memory. This volatile memory also includes additional higher levels of volatile memory, including cache memory, registers and buffers. Data that populates system memory 136 includes information handling system 100's operating system (OS) 138 and application programs 144. OS 138 includes a shell 140, for providing transparent user access to resources such as application programs 144. As depicted, OS 138 also includes kernel 142, which includes lower levels of functionality for OS 138, including providing essential services required by other parts of OS 138 and application programs 144, including memory management, process and task management, disk management, and mouse and keyboard management.

The hardware elements depicted in information handling system 100 are not intended to be exhaustive, but rather are representative to highlight essential components required by the present invention. For instance, information handling system 100 may include alternate memory storage devices such as magnetic cassettes, digital versatile disks (DVDs), Bernoulli cartridges, and the like. These and other variations are intended to be within the spirit and scope of the present invention.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

FIG. 3 is a diagram depicting different physical laptop orientations of the information handling system with a touch layer being moved between a display screen layer and a keyboard layer. Two components are keyboard component 310 and display screen component 330. Keyboard component 310 includes a keyboard side where keys are visible and usable, and a keyboard back side that, when closed, serves to protect the mobile unit. Display component 330 is hinged to keyboard component with a hinge assembly. Display component 330 includes a transparent display screen side and a display back side. The transparent display screen side is used to display information to the user, while the display back side serves to protect the unit, especially when the unit is in a closed configuration used to transport the unit.

Touch layer 320 is a transparent two-sided capacitive touch screen that can be rotated between keyboard component 310 and display component 330. In one embodiment, rotation of the touch layer is provided by a hinge that attaches the touch layer to at least one of the other components. Intermediate configuration 300 shows touch layer 320 being a separate layer that can be moved independently between the keyboard side of keyboard component 310 and the transparent display screen side of display component 330. By rotating the touch layer, the user can overlay the keyboard side with the touch layer as shown in configuration 301. Likewise, the user can rotate the touch layer to overlay the transparent display side of the display component as shown in configuration 302.

Sensors are included in the system to detect where the touch layer is in relation to the keyboard component and the display component, the angle between the keyboard component and the display component, movement of the touch layer, the keyboard component, and the display component, and orientation of the system in space (e.g., in a laptop configuration, closed configuration, tablet configuration, standing configuration, etc.). Examples of sensors that can be employed include keyboard overlay sensor 315, screen overlay sensor 335, and hinge and angular sensors 340. When the touch layer is proximate to, or overlaying, the keyboard included in keyboard component 310, keyboard overlay sensor 315 detects the presence of the touch layer over the keyboard. Likewise, when the touch layer is proximate to, or overlaying, the transparent screen included in display component 330, screen overlay sensor 335 detects the presence of the touch layer over the keyboard. Finally, hinge angular sensors 340 can detect the angles between the keyboard component, the touch layer, and the display component.

FIG. 4 is a diagram depicting different physical laptop orientations of the information handling system shown in a closed orientation, a standing orientation, and a tablet orientation. Protected configuration 401 depicts the system in a closed position that is suitable for transporting the system. In protected configuration 401, the outside cover of the system is formed by the back side of keyboard component 310 on one side and the back side of display component 330 on the other side. In protected configuration 401, touch layer is sandwiched between keyboard component 310 and display component 330, thus protecting the touch layer from inadvertent harm.

Two other configurations are shown in FIG. 4. Standing configuration 402 depicts the unit standing on the edges of keyboard component 310 and display screen component 330 with the hinges at the top of the configuration. The user enters standing configuration 402 by rotating the display component away from the keyboard component until an angle is formed between the backside of keyboard component 310 and the back side of display component 330. The user rotates touch layer 320 to overlay the transparent screen of the display screen component. The positioning of the touch layer over the transparent display screen can be performed before or after the rotation of the display component away from the keyboard component. In standing configuration 402, touch layer 320 is shown overlaying the transparent screen side of display screen component 330. Such a standing configuration would allow the user to interact with the touch screen surface while watching data or content being displayed on the display screen.

Finally, tablet configuration 403 depicts the unit in a tablet mode of operation with the back side of display component 330 being adjacent to, or touching, the back side of the keyboard 310. Tablet configuration can be seen as an extension of the standing configuration with the transparent screen side of display component 330 moved further away from the keyboard side of keyboard component 310 until the back sides of the respective components touch each other or are stopped due to the hinge employed to connect the display screen component to the keyboard component. While not shown, in one embodiment the unit can be oriented in “portrait” mode rather than “landscape” mode that is shown in FIGS. 3 and 4. When oriented in portrait mode, the contents displayed on the display screen are rotated ninety degrees to conform to the portrait orientation of the display screen. While portrait mode would be available in any of the shown configurations, portrait mode is often used when the system is in tablet configuration 403, depending on the contents that the user wishes to view on the display screen. For example, portrait mode is often desired when viewing a page of text, while landscape mode is often desired when watching content, such as a video. Sensors, discussed with respect to FIG. 1, are used to detect whether the system is being used in landscape mode or portrait mode.

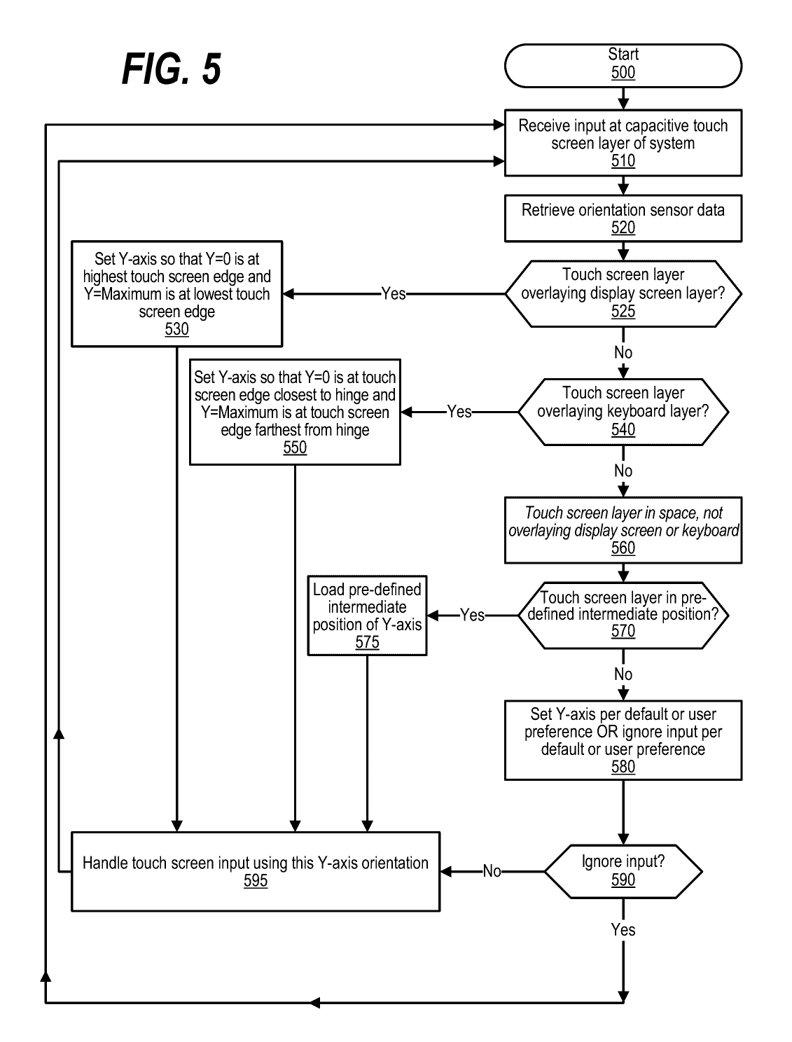

FIG. 5 is a flowchart showing steps performed to manage input from the touch layer based on the orientation of touch layer respective to other components of the information handling system. FIG. 5 processing commences at 500 and shows the steps taken by a process that handles input received at the touch layer of a system where the touch layer can be rotated between the keyboard component and the display component. At step 510, the process receives touch input at the capacitive touch layer of touch-enabled system. At step 520, the process retrieves orientation sensor data from sensors included in the information handling system. Based on the sensor data received, the process determines whether the touch layer is currently overlaying the display screen of the display component (decision 525). If the touch layer is currently overlaying the display screen of the display component, then decision 525 branches to the ‘yes’ branch to perform step 530. On the other hand, if the touch layer is not currently overlaying the display screen of the display component, then decision 525 branches to the ‘no’ branch for further processing. At step 530, the process sets the Y-axis so that Y=0 is at the highest touch screen edge and Y=Maximum is at the lowest touch screen edge. The X-axis is set so that X=0 is at the left-most touch screen edge and X=Maximum is at the right most touch screen edge.

Following the ‘no’ branch from decision 525, the process next determines as to whether the touch layer is currently overlaying the keyboard side of the keyboard component (decision 540). If the touch layer is currently overlaying the keyboard side of the keyboard component, then decision 540 branches to the ‘yes’ branch to perform step 550. On the other hand, if not touch layer overlaying keyboard layer, then decision 540 branches to the ‘no’ branch for further processing. At step 550, the process sets the Y-axis so that Y=0 is at the touch screen edge that is closest to hinge with the display screen and Y=Maximum is at the touch screen edge farthest from the hinge.

Following the ‘no’ branch from decision 540, at 560, the process determines that the touch input is being received while the touch layer is in an intermediate position between the display screen of the display component and the keyboard of the keyboard component. The process determines as to whether the touch layer is at a pre-defined intermediate position between the keyboard component and the display component (decision 570). If the touch layer is at a pre-defined intermediate position, then decision 570 branches to the ‘yes’ branch to perform step 575. For example, the user might configure an intermediate position that the user wishes to utilize when using a particular application. On the other hand, if the touch layer is not at a pre-defined intermediate position, then decision 570 branches to the ‘no’ branch to perform step 580. At step 575, the process loads a pre-defined intermediate position of Y-axis (e.g., as specified by the user, etc.).

Following the ‘no’ branch from decision 570, at step 580 the process sets the

Y-axis per a default setting or pre-defined user preference or the process ignores the input per default or user preference. The process determines as to whether to ignore the touch input (decision 590). If the touch input is being ignored, then decision 590 branches to the ‘yes’ branch bypassing step 595. On the other hand, if the input is not being ignored, then decision 590 branches to the ‘no’ branch to use the Y-axis orientation as set per default or user preference. At step 595, the process handles the touch screen input that was received using the Y-axis orientation that was set by the preceeding processing steps. Processing then loops back to step 510 to receive and process the next input received at the touch layer of the system.

While particular embodiments have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. An apparatus comprising:
a keyboard component that comprises a keyboard side and a keyboard back side;
a display component that comprises a transparent display screen side and a display back side, wherein the display component is connected to the keyboard component with a first hinge;
one or more processors and a memory coupled to at least one of the processors, wherein the processors and the memory are accessible to one or more of the components; and
a two-sided transparent touch layer that can be rotated independently between the two components, wherein the touch layer is coupled to at least one of the components.

2. The apparatus of claim 1, wherein the two-sided touch screen layer is rigid.

3. The apparatus of claim 1, wherein the two-sided touch screen layer is coupled to at least one of the components with a second hinge.

4. The apparatus of claim 1 further comprising:
a sensor that detects an event of the two-sided touch layer with respect to one or more of the first and second components wherein the sensor is selected from the group consisting of a rotation sensor, a proximity sensor, a position sensor, and a movement sensor.

5. The apparatus of claim 2 further comprising:
an activated side of the two-sided transparent touch layer that is available for user input, wherein the activated side is identified as available for the user input based on the sensor detection.

6. The apparatus of claim 2 wherein the touch layer has a physical orientation with respect to a logical x-y orientation of the display screen component and based on a position of the touch layer with respect to the display screen component.

7. The apparatus of claim 4 further comprising:
an activated side of the touch layer that is available for user input, wherein the activated side is identified as available for the user input based on the sensor detection; and
an x-y coordinate system applied to the activated side of the touch layer based on the physical orientation.

8. The apparatus of claim 5 wherein the x-y coordinate system applied to the activated side of the touch layer matches a second x-y coordinate system applied to the display screen component in response to identifying that the touch layer overlays the display screen component.

9. The apparatus of claim 1 further comprising:
one or more sensors wherein at least one of the sensors detects an orientation of the touch screen component as being either in a portrait orientation or a landscape orientation;
at least one of the sensors detects an active side of the touch layer that is the side of the touch layer that is being touched by a user; and
an input coordinate of the touch layer with an X axis and a Y axis that are set based upon the detected orientation and the active side of the touch layer.

10. An apparatus comprising:
a two-sided transparent touch layer that receives touch input on both sides;
an edge along one of the sides of the touch layer attached to a hinge assembly;
a display component attached to a keyboard component with the hinge assembly, wherein the touch layer can rotate between at least one side of the display component and at least one side of the keyboard component.

11. The apparatus of claim 10 further comprising:
one or more sensors wherein at least one of the sensors detects an orientation of the touch screen component as being either in a portrait orientation or a landscape orientation;
at least one of the sensors detects an active side of the touch layer that is the side of the touch layer that is being touched by a user; and
an input coordinate of the touch layer with an X axis and a Y axis that are set based upon the detected orientation and the active side of the touch layer.

12. A method comprising:
receiving a touch input at an active side of a touch layer of a system, wherein the touch layer is moveable between a display component and a keyboard component, and;
retrieving sensor data pertaining to at least one of the components and sensor data pertaining to the active side of the touch layer; and
processing the touch input based upon the retrieved sensor data.

13. The method of claim 12 further comprising:
detecting a position of the two-sided touch layer with respect to at least one of the components; and
identifying an activated side of the two-sided transparent touch layer that is available for user input, wherein the activated side is identified based on the detecting.

14. The method of claim 12 further comprising:
receiving touch input from a user at the activated side of the two-sided transparent touch layer that is available for user input.

15. The method of claim 12 further comprising:
detecting a physical orientation of the touch layer with respect to a logical x-y orientation of the display screen component and based on the position of the touch layer with respect to the display screen component.

16. The method of claim 15 further comprising:
establishing an x-y coordinate system that is applied to the activated side of the touch layer based on the physical orientation.

17. The method of claim 16 wherein the x-y coordinate system applied to the activated side of the touch layer matches a second x-y coordinate system applied to the display screen component in response to identifying that the touch layer overlays the display screen component.

18. The method of claim 12 further comprising:
receiving inputs from one or more sensors wherein at least one of the sensors detects an orientation of the touch screen component as being either in a portrait orientation or a landscape orientation;
detecting, from at least one of the sensors, an active side of the touch layer that is the side of the touch layer that is being touched by a user; and
establishing an input coordinate of the touch layer with an X axis and a Y axis that are set based upon the detected orientation and the active side of the touch layer.

19. The method of claim 12 further comprising:
receiving a first touch input on a first side of the two-sided capacitive touch layer; and
receiving a second touch input on a second side of the two-sided capacitive touch layer.

20. The method of claim 12 further comprising:
detecting an orientation of the touch layer, wherein the orientation is selected from the group consisting of a portrait orientation and a landscape orientation.
